(19) United States
(12) Patent Application Publication
(10) Pub. No.: US 2026/0340307 A1
(43) Pub. Date: Oct. 29, 2026

(54) TEXT CONTENT REFINEMENT USING MACHINE LEARNING

(71) Applicant: eBay Inc., San Jose, CA (US)

(72) Inventor: Lei Liu, Shanghai (CN)

(73) Assignee: eBay Inc., San Jose, CA (US)

(21) Appl. No.: 19/191,433

(22) Filed: Apr. 28, 2025

(51) Int. Cl. G06F 40/40; G06F 40/279

(52) U.S. Cl. CPC G06F 40/40; G06F 40/279

(57) ABSTRACT

Text content refinement using machine learning is described. In one or more examples, a set of items is identified from a plurality of items that have been selected for acquisition from a listing digital service of a service provider system and a set of text content is located from listings associated with the set of items. A set of refinement prompts are then generated based on the set of text content for processing by a language model. In response, training data is received including a set of refined text content from the language model responsive to processing of the set of refinement prompts using machine learning. A machine-learning model is trained using the training data to implement generative artificial intelligence (AI) to generate text content, automatically and without user intervention, as refined based on input text content.

### BACKGROUND

Service provider systems are configurable to support listings of a multitude of items for use in a variety of scenarios. Service provider systems, for instance, may support output of listings via an online platform that are usable to locate a respective item of interest, from books, music, digital videos, physical items that are available for sale, mechanical parts, auction items, and so forth. To locate the items, the listings typically include text content that is used to describe a respective item being represented by the listing.

However, conventional techniques used in support of input of this text content in real-world scenarios are fractured across a variety of naming conventions and typically rely on manual inputs and specialized knowledge gained over time to implement. Accordingly, conventional techniques are prone to error, inefficient, and often fail in an ability to support locating a particular item of interest due to inaccuracies and misunderstandings in the text content.

### SUMMARY

Text content refinement using machine learning is described. In one or more examples, a listing generation service employs a machine-learning model to generate refined text content based on input text content, e.g., received via a user interface. To do so, the machine-learning model is trained based on training data that has exhibited accuracy in describing a respective item and thus supports a corresponding increase in accuracy in operation of the machine-learning model to refine the input text content.

To generate the training data in one or more examples, a listing generation service may locate a set of listings of items from a plurality of item listings that have been acquired via a service provider system. The set of listings are then refined through use of a language model by the listing generation system as a way to improve accuracy and support concise descriptions as part of the text content. The listing generation system, for instance, may form a refinement prompt based on the set of listings and include one or more instructions to guide processing by the language model. The instructions may specify that the language model is to remove redundant or noisy words, reorder aspects, perform normalization and expand abbreviations to a full name, add aspects, rewrite and expand descriptive words, and so forth.

The listing generation system then receives refined text content as training data from the language model responsive to processing the refinement prompt. The training data is usable to train a machine-learning model to generate refined text content based on input text content, e.g., to generate a title for a listing, a description of an item represented in the listing, and other text content.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ text content refinement techniques using machine learning as described herein.

FIG. 2 depicts a system in an example implementation showing operation of a listing generation service of FIG. 1 in greater detail as generating training data and using the training data to train a machine-learning model to perform text content refinement.

FIG. 3 depicts an example implementation showing instructions includable in a refinement prompt for processing by a language model to generate the training data.

FIG. 4 is a flow diagram depicting an algorithm as a step-by-step procedure in an example implementation of operations performable for accomplishing a result of training data generation and use of the training data to train a machine-learning model for text content refinement.

FIG. 5 depicts a system in an example implementation showing operation of a listing generation service of FIG. 1 in greater detail as operating a trained machine-learning model of FIG. 2 to generate refined text content from input text content.

FIG. 6 is a flow diagram depicting an algorithm as a step-by-step procedure in an example implementation of operations performable for accomplishing a result of text content refinement using machine learning through use of a trained machine-learning model.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

### Overview

Service provider systems are configurable to support listings of a multitude of items in a variety of scenarios. Service provider systems, for instance, may process and organize large volumes of diverse data to handle a vast array of products, each with mutually exclusive attributes, specifications, and categorizations. To locate items, the listings typically include text content that is used to describe a respective item being represented by the listing, e.g., a title, a description of the item, and so forth. Thus, accuracy of the text content in describing an item directly supports an ability to locate a respective item.

However, conventional techniques used in support of generating accurate listings in real-world scenarios are challenged by the dynamic nature of items including inventory, pricing, and product details. Therefore, conventional techniques struggle in accounting for variations in product descriptions and different naming conventions used for the items. Conventional techniques, for instance, typically rely on manual inputs and specialized knowledge gained over time to accurately implement. Accordingly, conventional techniques are prone to error, are computationally inefficient, and often fail in an ability to maintain consistency in how text content is presented as part of the listing.

Further, conventional techniques used to implement natural language processing to address these technical challenges often introduce additional complexities. Examples of these additional complexities include an inability to understand and generate human-readable text that accurately describes items, an inability to take into account nuances in language and product-specific terminology for particular types of items, and an inability to balance comprehensive item descriptions with concise, relevant text content that aligns with platform-specific criteria and is optimized for search engine visibility.

Accordingly, text content refinement techniques using machine learning are described. In one or more examples, a listing generation service employs a machine-learning model to generate refined text content based on input text content, e.g., received via a user interface. A machine-learning model, for instance, may receive input text input as “Men's shoe, basketball, BrandX, used once White, Size 12,” which is refined to generate a refined text content as “BrandX Men's Retro Heritage Sneakers, Sized 12, White, Slightly Used.”

To do so, the machine-learning model is trained based on training data that has exhibited accuracy in describing a respective item and thus supports a corresponding increase in accuracy in operation of the machine-learning model to refine the input text content. This increase in accuracy supports increases in accuracy and operational efficiency of a variety of computational functionalities that rely on the text content, such as to locate a corresponding item using a search engine.

In order to generate the training data, a listing generation service is configurable to locate a set of listings of items from a plurality of item listings that have been acquired via a service provider system, e.g., downloaded, purchased, viewed, read, and so forth. By acquiring this set of listings, text content included in the listing has exhibited accuracy in representing corresponding items because those items have been selected for acquisition based on the text content.

Selection of the set of listings may be performed in a variety of ways, an example of which includes use of an acquisition threshold. The acquisition threshold, for instance, may specify a threshold number of acquisitions of an item for a respective listing to qualify, based on a number of acquisitions as well as a number of interactions that did not involve acquisition (e.g., as a proportion), and so on.

The set of listings are then refined through use of a language model (e.g., a large language model (LLM)) by the listing generation system as a way to improve accuracy and support concise descriptions as part of the text content. The listing generation system, for instance, may form a refinement prompt based on the set of listings and include one or more instructions to guide processing by the language model. The instructions, for instance, may specify that the language model is to remove redundant or noisy words, reorder aspects, perform normalization and expand abbreviations to a full name, add aspects, rewrite and expand descriptive words, and so forth.

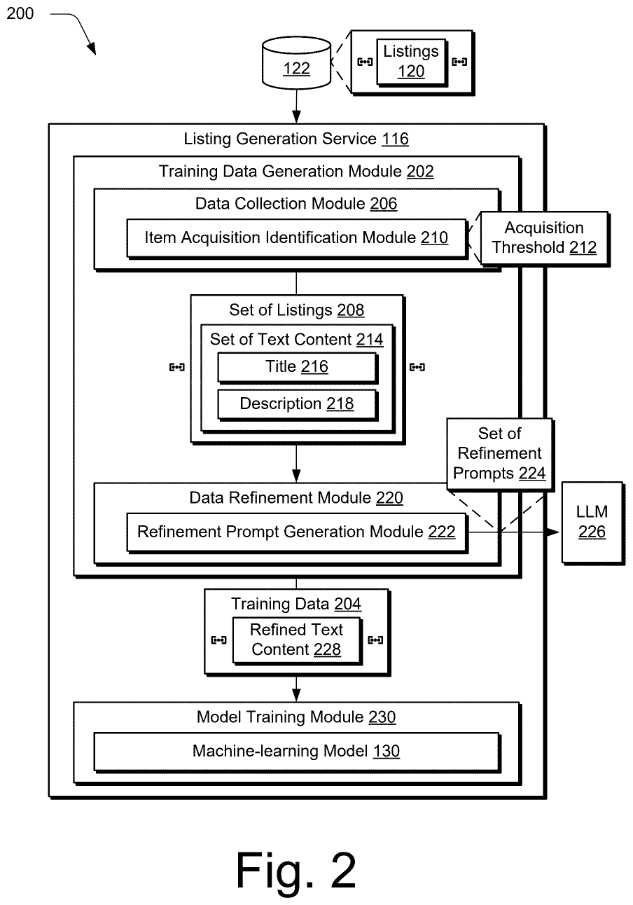

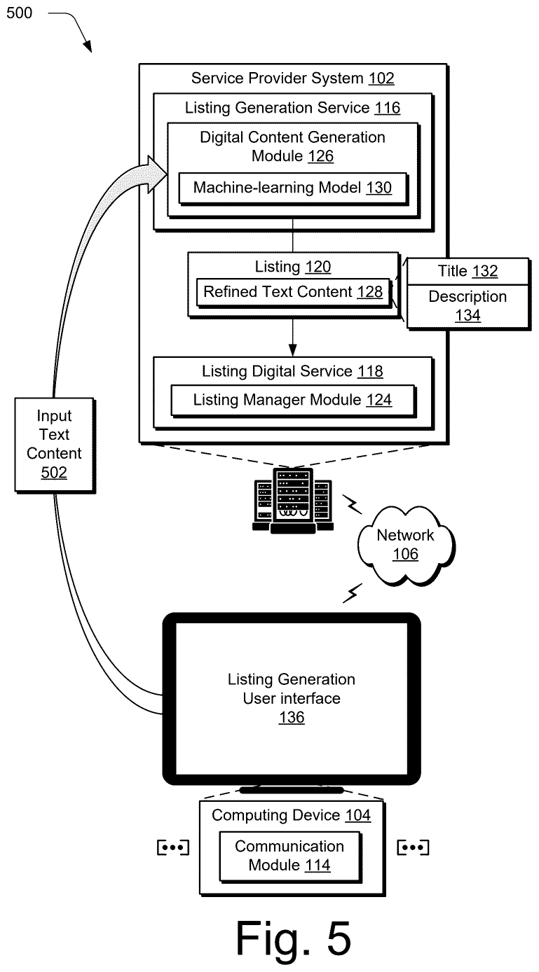

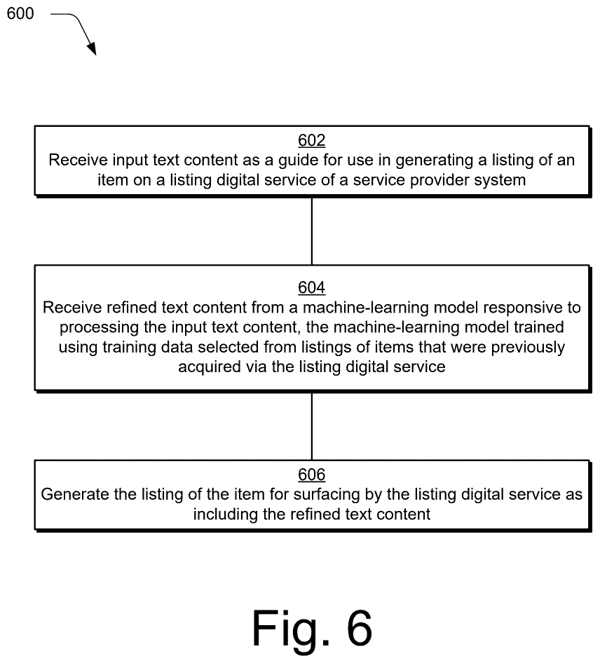

The listing generation system then receives refined text content as training data from the language model responsive to processing the refinement prompt. The training data is then used to train a machine-learning model to generate refined text content based on input text content, e.g., to generate a title for a listing, a description of an item represented in the listing, and other text content. In this way, the machine-learning model once trained is operable to generate the text content, automatically and without user intervention with a decrease in computational resource utilization, an increase in user efficiency in generating a listing, and so forth. Further discussion of training data generation and training of a machine-learning model may be found in relation to FIGS. 2-4. Further discussion of operation of a trained machine-learning model for text content refinement may be found in relation to FIGS. 5 and 6.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provides a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Text Content Refinement Environment

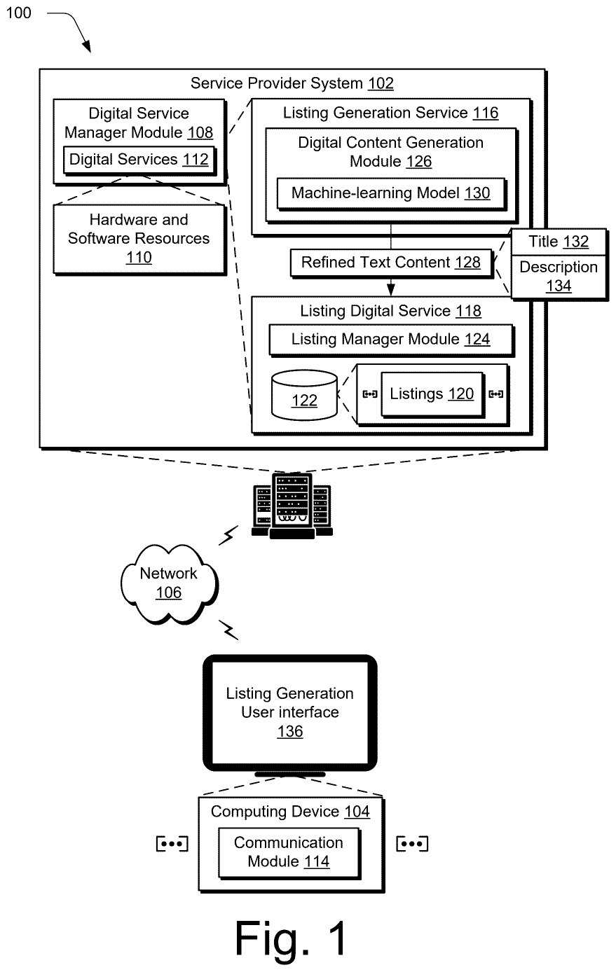

FIG. 1 is an illustration of a digital medium environment 100 in an example implementation that is operable to employ text content refinement techniques using machine learning as described herein. The illustrated environment 100 includes a service provider system 102 and a computing device 104 that are communicatively coupled, one to another, via a network 106. Computing devices are configurable in a variety of ways.

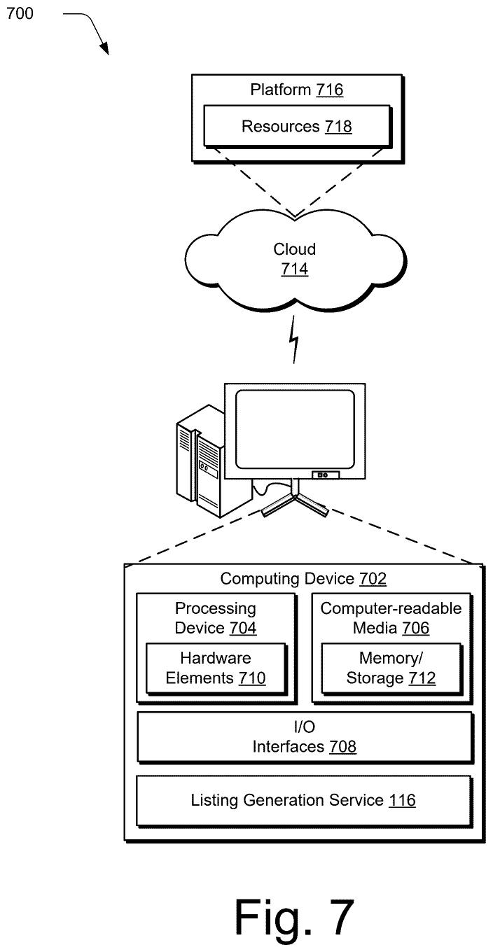

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 7.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, auction service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement a listing generation service 116 and a listing digital service 118. The listing generation service 116 is configured to generate listings 120, which are illustrated as stored in a storage device 122 at the listing service 118. Listings 120 refer to digital content that is usable to locate a corresponding item, e.g., a digital item, a physical item, and so forth.

Output of the listings is then controlled by a listing manager module 124 in support of a variety of usage scenarios. Accordingly, listings 120 support a variety of functionalities in various real-world scenarios to aid location of corresponding items. For instance, in a commerce digital service, users may employ search engines to find specific products by entering keywords related to brand names, product features, or categories, with the search results displaying relevant listings that match the query.

On auction websites, users may navigate through categorized listings to discover collectibles or rare items, relying on detailed descriptions and images to make informed bidding decisions. In online marketplaces for used goods, users may create listings for secondhand items, allowing other users to browse through categories or use filters to find local deals on furniture, electronics, or vehicles. Library catalogs often utilize listings to help patrons locate books, journals, or multimedia resources by searching for titles, authors, or subjects. Additionally, job seekers may use online job boards to search through listings of available positions, filtering results by industry, location, or required qualifications to find suitable career opportunities. A variety of other examples are also contemplated.

Conventional techniques used to generate listings face numerous technical challenges that hinder effectiveness and efficiency. Conventional techniques, for instance, often struggle with inconsistent data formats and varying levels of detail provided by different data sources, making it difficult to standardize and normalize listing information across a platform. Manual input processes are prone to human error, leading to inaccuracies in product descriptions, pricing, or categorization.

Scalability issues arise when dealing with large volumes of listings, as conventional systems may struggle to process and update information in real-time, especially during peak periods or when handling sudden influxes of new items. Maintaining data integrity across multiple platforms or marketplaces also presents synchronization challenges, potentially resulting in outdated or conflicting information. Additionally, conventional techniques often lack sophisticated natural language processing capabilities, making it challenging to generate compelling and search-engine-optimized descriptions automatically or to effectively handle multilingual listings and regional variations in product terminology.

Accordingly, to address these and other technical challenges the listing generation service 116 employs a digital content generation module 126 that is configured to generate refined text content 128 using a machine-learning model 130 for inclusion as part of the listings 120. The refined text content 128, for instance, may include a title 132 of the listings 120, a description 134 of the item included in the listing 120, and so forth. To do so, the machine-learning model 130 is trained using training data to refine input text content entered via a listing generation user interface 136 in a manner that is optimized to support computational functionalities as well as user navigation with increased accuracy and efficiency. Further discussion of generation of training data and use of the training data to train the machine-learning model 130 is described in the following section.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Training Data Generation for Text Content Refinement

The following discussion describes training data generation and training techniques that are implementable utilizing the described systems and devices. Aspects of the procedure may be implemented in hardware, firmware, software, or a combination thereof. The procedures are shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

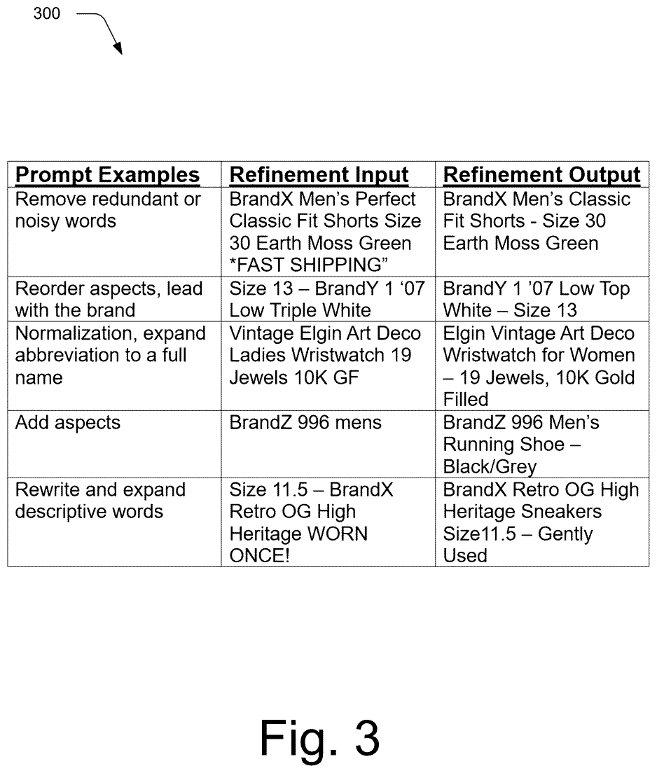

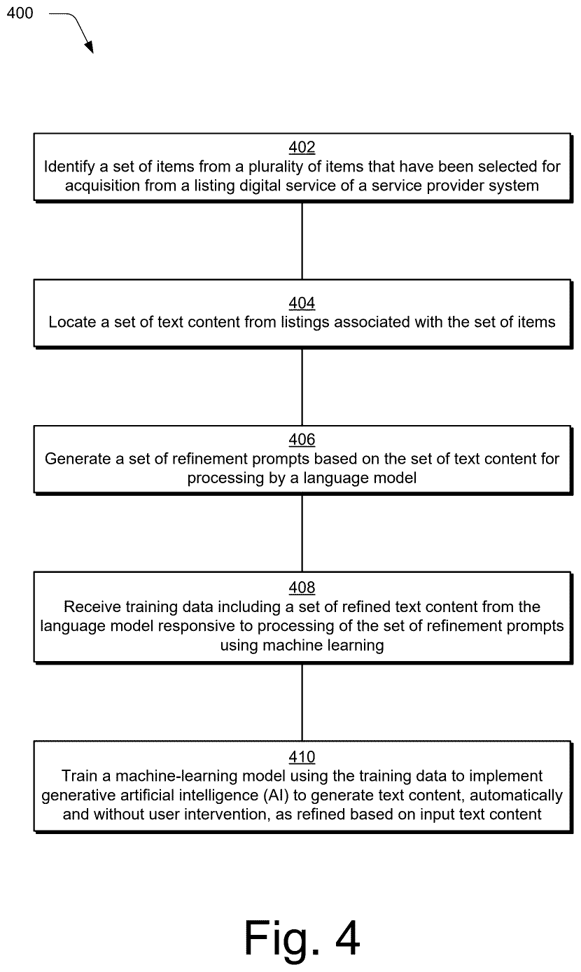

FIG. 2 depicts a system 200 in an example implementation showing operation of the listing generation service 116 of FIG. 1 in greater detail as generating training data and using the training data to train a machine-learning model to perform text content refinement. FIG. 3 depicts an example table 300 showing instructions includable in a refinement prompt for processing by a language model to generate the training data. FIG. 4 is a flow diagram depicting an algorithm 400 as a step-by-step procedure in an example implementation of operations performable for accomplishing a result of training data generation and use of the training data to train a machine-learning model for text content refinement. In the following discussion, reference is made in parallel to FIGS. 2-4.

To begin in this example, a training data generation module 202 is employed by the listing generation service 116 to generate training data 204. To do so, a data collection module 206 is configured to identify a set of items from a plurality of items that have been selected for acquisition from a listing digital service 118 of a service provider system 102 (block 402). The data collection module 206, for instance, identifies a set of listings 208 that have resulted in acquisition of a respective set of items represented by the listings, e.g., physical items, digital items, and so forth. What it means to acquire the items described by the listing varies based on a variety of usage scenarios, such as to purchase of a good or service, download of digital content, request to borrow a book, purchase a car part, and so forth.

The data collection module 206, for instance, employs an item acquisition identification module 210 that employs an acquisition threshold 212 that is used to select the set of listings 208 from the plurality of listings 120 that meet the threshold. The acquisition threshold 212, for example, may specify a threshold number of acquisitions for qualification as part of the set of listings 208, e.g., “downloaded X amount of times.” In another example, the acquisition threshold 212 also takes into account a number of times a corresponding listing 120 is accessed. Therefore, in this example the acquisition threshold 212 is defined based on a relationship of a number of times a respective item is acquired and a number of times a respective listing is accessed, e.g., as a ratio. A variety of other examples are also contemplated.

In this way, the data collection module 206 obtains a set of listings 208 including a set of text content 214, e.g., a title 216, description 218, and so forth. Identification of a set of listings 208 that have been acquired from a listing digital service 118 promotes accuracy of text content included in the set of listings 208 by leveraging successful real-world examples. Listings that have been acquired (e.g., through purchases, downloads, or other forms of user engagement) demonstrate a level of effectiveness in accurately representing corresponding items. As a result, the set of listings 208 have a proven ability to support operation with computational resources (e.g., a search engine), attract and convert user interest (e.g., indicating that the text content effectively communicates key product information) and so forth.

By focusing on an acquired set of listings 208, training of the machine-learning model 130 is performed to analyze and learn from text content that has already shown success. This approach, for instance, may help filter out less effective or inaccurate listings having errors, providing a higher quality dataset for training and refinement processes of the machine-learning model 130. Additionally, the acquired set of listings 208 may reflect current market trends, user preferences, and effective communication strategies, further enhancing the relevance and accuracy of the set of text content 214 used for future listing generation. In this way, leveraging the set of listings 208 may improve operation of training and use of the machine-learning model 130.

The training data generation module 202 is also configured to further refine the set of listings 208, thereby further improving accuracy and operation of a machine-learning model 130 trained on the training data 204. Functionality to do so is represented by a data refinement module 220. The data refinement module 220 begins by locating, by the computing device, a set of text content 214 from listings associated with the set of items (block 404), e.g., a title 216, a description 218, or other text content included in the set of listings 208.

A refinement prompt generation module 222 is then employed to generate a set of refinement prompts 224 based on the set of text content 214 for processing by a language model (block 406), e.g., an LLM 226. To do so, a refinement prompt generation module 222 includes the set of text content 214 as well as instructions for processing that is to be performed by the language model (e.g., the LLM 226) in order to generate refined text content 228.

In one or more implementations, the training data generation process may include creation of pairs of titles or descriptions, where each pair includes a high-quality, rewritten title and a corresponding low-quality title. Title pairs, for instance, can be used to train the machine-learning model 130 to recognize and differentiate between good and bad quality titles. For example, a high-quality title may include “BrandX Men's Leather Oxford Dress Shoes—Black-Size 10—Italian Made,” while its low-quality counterpart may recite “mens shoes BrandX blk sz10 FAST SHIP!!!” By exposing the machine-learning model 130 to numerous such pairs, the machine-learning model 130 learns to identify key characteristics that contribute to title quality and effectiveness.

To generate these high-quality titles, a variety of approaches may be employed. One such approach involves leveraging expertise of professionals who have extensive experience in crafting effective product listings. In another approach, an advanced large language model (LLM) may be utilized to generate refined, high-quality titles based on input data. Both approaches may also be used in conjunction to create a diverse and robust set of training data. The process may begin with a set of seed titles, which serve as inputs for generating both the high-quality and low-quality versions. For instance, a seed title of “red t-shirt size L cotton” may be transformed into a high-quality title “Premium Cotton T-Shirt—Vibrant Red—Large—Soft Comfort Fit” and a low-quality version “RED SHIRT L 100% COTTON CHEAP PRICE LOOK!!!”

In generating low-quality titles for the pairing, the listing generation service 116 may intentionally introduce chaotic elements. Introduction of chaotic elements may include excessive use of capital letters, irrelevant promotional text, misspellings, or poorly structured information. For example, “AMAZING DEAL!!! green SNEAKERS comfy size 9 MEN'S fast shipping BUY NOW” represents a low-quality title with multiple issues that the machine-learning model 130 is to learn to avoid.

The training data may encompass different item categories to ensure the machine-learning model 130 is configured to generalize across various product types. For instance, a first set of title pairs may focus on electronics, while a second set may cover fashion items. The machine-learning model 130 may also extrapolate learned patterns to new domains. This approach allows for efficient training while still enabling the machine-learning model 130 to address diverse product listings. The same training scenario may be extended beyond titles to include other aspects of item listings, such as product descriptions, item condition statements, or technical specifications, allowing the machine-learning model 130 to refine various components of a listing holistically.

In one or more implementations, the machine-learning model 130 may be pre-trained, e.g., a sophisticated LLM which may be used “as is” or “fine-tuned” using the training data as described above. Additionally, the machine-learning model 130 may be provided with examples to help it better understand our title rewrite criteria.

FIG. 3 depicts a table 300 showing instructions includable in a refinement prompt for processing by a language model to generate the training data. In this example, the table 300 includes a first column of “prompt examples” of instructions useable for inclusion in the set of refinement prompts 224. A second column is labeled as “refinement input” that includes the set of text content 214 parsed from the set of listings 208 by the data refinement module 220. A third column labeled as “refinement output” includes examples of refined text content 228 output by the LLM 226 based on the instructions of the refinement prompts 224 and the set of text content 214.

An instruction of “remove redundant or noisy words” as included in the refinement prompt 224, for instance, is usable to refine text content of “BrandX Men's Perfect Classic Fit Shorts Size 30 Earth Moss Green *FAST SHIPPING*” into refined text content of “BrandX Men's Classic Fit Shorts—Size 30 Earth Moss Green.” Likewise, an instruction to “reorder aspects, lead with the brand” is usable to refined text content of “Size 13—BrandY 1 '07 low Triple White” into refined text content of “BrandY 1 '07 Low top White—Size 12.” Additionally, an instruction for “normalization, expand abbreviation to a full name” is usable by the LLM 226 to process text content of “Vintage Elgin Art Deco Ladies Wristwatch 19 Jewels 10K GF” into a refined text content of “Elgin Vintage Art Deco Wristwatch for Women—19 Jewels, 10K Gold Filled.

Further, an instruction for “add aspects” is usable to cause the LLM 226 to hallucinate additional aspects for inclusion, e.g., to process text content of “BrandZ 996 mens” into a refined text content of “BrandZ 996 Men's Running Shoe—Black/Grey.” In this way, the data refinement module 220 may take advantage of what otherwise is a technical challenge and inaccuracy in other scenarios to improve a descriptive ability of the refined text content 228. An instruction to “rewrite and expand descriptive words” is usable to instruct the LLM 226 to process text content “Size 11.5—BrandX Retro OG High Heritage WORN ONCE!” into refined text content 228 as “BrandX Retro OG High Herigate Sneakers Size 11.5—Gently Used.” A variety of other instructions are also contemplated.

Returning the discussion again to FIG. 2, the training data generation module 202 generates the training data 204 as including the refined text content 228, which is passed as an input to a model training module 230. The model training module 230 therefore receives the training data 204 including the refined text content 228 from the language model responsive to processing of the set of refinement prompts using machine learning (block 408). The model training module 230 is then employed to train the machine-learning model 130 using the refined text content refined text content 228 of the training data 204 to implement generative artificial intelligence (AI) to generate text content, automatically and without user intervention, as refined based on input text content (block 410).

The machine-learning model 130, once trained on this refined text content 228, supports numerous technical advantages in generating new listings. For instance, when a user inputs basic information about a smartphone to be list, such as “xPhone 2 64 GB black good condition,” the machine-learning model 130 can automatically generate a refined title like “Mange xPhone Dos—64 GB—Midnight Black—Excellent Condition-Unlocked.” This refined text content incorporates standardized terminology, includes relevant details, and follows a consistent format that improves searchability and user comprehension. The machine-learning model 130 can also generate a refined description 218, highlighting key features and specifications in a well-structured format, without involving manual input of this information. This automation increases user efficiency as well as promotes data accuracy by ensuring consistency and accuracy of refined text content 228 across listings, thereby improving search relevance in search engine processing and user experience in navigating to particular listings and corresponding items of interest as further described below.

### Example Text Content Refinement Using a Machine-learning Model

The following discussion describes text content refinement techniques using machine learning that are implementable utilizing the described systems and devices. Aspects of the procedure may be implemented in hardware, firmware, software, or a combination thereof. The procedures are shown as a set of blocks that specify operations performable by hardware and are not necessarily limited to the orders shown for performing the operations by the respective blocks. Blocks of the procedure, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

FIG. 5 depicts a system 500 in an example implementation showing operation of the listing generation service 116 of FIG. 1 in greater detail as employing the trained machine-learning model 130 of FIG. 2 to generate refined text content from input text content. FIG. 6 is a flow diagram depicting an algorithm 600 as a step-by-step procedure in an example implementation of operations performable for accomplishing a result of text content refinement using machine learning through use of a trained machine-learning model. In the following discussion, reference is made in parallel to FIGS. 5 and 6.

In this example, the machine-learning model 130, trained as described in relation to FIGS. 2-4, is implemented by a digital content generation module 126 of the listing generation service 116 to assist in generation of a listing 120. To do so, the digital content generation module 126 receives input text content 502 as a guide for use in generating a listing 120 of an item on a listing digital service 118 of a service provider system 102 (block 602).

The digital content generation module 126, for instance, may receive input text content 502 in various forms and from different sources. For example, a seller using a mobile device may input a brief description of an item to be listed, such as “vintage camera 35 mm film SLR.” This input text content 502 serves as a starting point for the machine-learning model 130 for refinement.

In another scenario, the input text content 502 may be extracted from an existing product database or catalog. For instance, a retailer migrating an inventory to a new commerce platform may provide basic product information such as “men's running shoe, BrandY, model Z, size range 7-13, available colors: black, white, red.” The digital content generation module 126 then uses this input to create comprehensive listings for each variant of the product.

The listing generation service 116 may also accept input text content 502 from automated systems. For example, a manufacturer's inventory management system may automatically send product specifications to the service provider system 102 when new items are available for sale. Accordingly, the input text content 502 may include technical details such as “Smartphone, 6.1-inch OLED display, 5G capable, 128 GB storage, dual rear cameras (12 MP wide+12 MP ultrawide).” The digital content generation module 126 then processes this information to create computer and search compatible listings that highlight key features while maintaining technical accuracy as further described below.

In each of these scenarios, the input text content 502 serves as a guide, providing initial information that the machine-learning model 130 uses to generate a full, refined listing 120. This approach allows for efficient creation of standardized, high-quality listings 120 automatically and without further user intervention across a wide range of product categories and seller types, enhancing the overall effectiveness of the listing digital service 118.

As part of this, the machine-learning model 130 is employed to generate refined text content 128 (e.g., a title 132 and/or description 134) by processing the input text content 502. The machine-learning model 130 is trained using training data selected from listings of items that were previously acquired via the listing digital service (block 604) as described in relation to FIGS. 2-4. For example, a seller may input “vintage leather jacket brown size M” as the input text content 502. The machine-learning model 130, leveraging training on previously successful listings, may then generate a refined title 132 such as “Vintage Brown Leather Motorcycle Jacket—Men's Medium—Classic Biker Style” and a description 134 that includes details like “Genuine leather, zip front closure, notched collar, two side pockets, excellent condition, approximate measurements: chest 40, length 26.”

The training data used to train the machine-learning model 130 is selected as previously described from listings of items that were previously acquired via the listing digital service 118. This selection process may involve analyzing transaction data to identify listings that resulted in successful sales or high user engagement. For instance, the listing generation service 116 may prioritize training data from listings of electronics that are purchased within twenty-four hours of being listed, or fashion items that received a high number of “watch” or “favorite” actions from users. By focusing on these successful listings, the machine-learning model 130 learns patterns and attributes that contribute to effective item descriptions and titles.

The training process, as described in relation to FIGS. 2-4, involves several steps to refine and optimize the selected listings. For example, a data refinement module 220 may process a successful listing for a smartphone, transforming an original title like “xPhone B 64 GB Space Gray Great Condition Fast Shipping!” into a standardized and informative format such as “BrandB xPhone B—64 GB—Space Gray—Excellent Condition—Unlocked.” This refined text content 228 becomes part of the training data 204 used to train the machine-learning model 130, enabling the machine-learning model 130 to generate similarly refined and effective listings when processing new input text content 502.

The digital content generation module 126 then generates the listing 120 of the item for surfacing by the listing digital service 118 as including the refined text content 128 (block 606). This process may involve several steps to ensure the listing 120 is optimized for visibility and user engagement. For example, if the refined text content 128 includes a title “Vintage Leather Motorcycle Jacket—Men's Large—Black—Excellent Condition,” the digital content generation module 126 may structure this information within the listing 120 to highlight key attributes such as brand, size, color, and condition.

In addition to the title, the digital content generation module 126 may incorporate other elements of the refined text content 128 into various sections of the listing 120. For instance, a detailed product description 134 generated by the machine-learning model 130 may be formatted with bullet points to emphasize features like “Genuine cowhide leather,” “Zippered cuffs,” and “Two interior pockets.” The digital content generation module 126 may also use the refined text content to populate relevant fields such as item condition, size, and color, ensuring consistency across parts of the listing. Furthermore, the digital content generation module 126 may leverage the refined text content to generate appropriate tags or keywords, enhancing discoverability of the listing 120 through search functions within the listing digital service 118. Once the listing 120 is fully generated, it becomes available for surfacing through various channels of the listing digital service 118 by the listing digital service 118, such as search results, category browsing, or personalized recommendations, potentially increasing visibility to potential buyers interested in vintage clothing or motorcycle gear. A variety of other examples are also contemplated.

### Example System and Device

FIG. 7 illustrates an example system generally at 700 that includes an example computing device 702 that is representative of one or more computing systems and/or devices that implement the various techniques described herein. This is illustrated through inclusion of the listing generation service 116. The computing device 702 is configurable, for example, as a server of a service provider, a device associated with a client (e.g., a client device), an on-chip system, and/or any other suitable computing device or computing system.

The example computing device 702 as illustrated includes a processing device 704, one or more computer-readable media 706, and one or more I/O interface 708 that are communicatively coupled, one to another. Although not shown, the computing device 702 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 704 is representative of functionality to perform one or more operations using hardware. Accordingly, the processing device 704 is illustrated as including hardware element 710 that is configurable as processors, functional blocks, and so forth. This includes implementation in hardware as an application specific integrated circuit or other logic device formed using one or more semiconductors. The hardware elements 710 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 706 is illustrated as including memory/storage 712 that stores instructions that are executable to cause the processing device 704 to perform operations. The computer-readable storage medium is configured for storing instructions that, responsive to execution by the processing device, causes the processing device to perform operations. The memory/storage 712 represents memory/storage capacity associated with one or more computer-readable media. The memory/storage 712 includes volatile media (such as random access memory (RAM)) and/or nonvolatile media (such as read only memory (ROM), Flash memory, optical disks, magnetic disks, and so forth). The memory/storage 712 includes fixed media (e.g., RAM, ROM, a fixed hard drive, and so on) as well as removable media (e.g., Flash memory, a removable hard drive, an optical disc, and so forth). The computer-readable media 706 is configurable in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 702. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 710. The computing device 702 is configured to implement particular instructions and/or functions corresponding to the software and/or hardware modules. Accordingly, implementation of a module that is executable by the computing device 702 as software is achieved at least partially in hardware, e.g., through use of computer-readable storage media and/or hardware elements 710 of the processing device 704. The instructions and/or functions are executable/operable by one or more articles of manufacture (for example, one or more computing devices 702 and/or processing devices 704) to implement techniques, modules, and examples described herein.

The techniques described herein are supported by various configurations of the computing device 702 and are not limited to the specific examples of the techniques described herein. This functionality is also implementable all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 include applications and/or data that can be utilized while computer processing is executed on servers that are remote from the computing device 702. Resources 718 can also include services provided over the Internet and/or through a subscriber network, such as a cellular or Wi-Fi network.

The platform 716 abstracts resources and functions to connect the computing device 702 with other computing devices. The platform 716 also serves to abstract scaling of resources to provide a corresponding level of scale to encountered demand for the resources 718 that are implemented via the platform 716. Accordingly, in an interconnected device embodiment, implementation of functionality described herein is distributable throughout the system 700. For example, the functionality is implementable in part on the computing device 702 as well as via the platform 716 that abstracts the functionality of the cloud 714.

In implementations, the platform 716 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
identifying, by a computing device, a set of items from a plurality of items that have been selected for acquisition from a listing digital service of a service provider system;
locating, by the computing device, a set of text content from listings associated with the set of items;
generating, by the computing device, a set of refinement prompts based on the set of text content for processing by a language model;
receiving, by the computing device, training data including a set of refined text content from the language model responsive to processing of the set of refinement prompts using machine learning; and
training, by the computing device, a machine-learning model using the training data to implement generative artificial intelligence (AI) to generate text content, automatically and without user intervention, as refined based on input text content.

2. The method as described in claim 1, wherein the set of text content is a title, respectively, of the set of items from a set of listings of the set of items from the listing digital service.

3. The method as described in claim 1, wherein the set of text content is a description, respectively, of the set of items from a listing of the set of items from the listing digital service.

4. The method as described in claim 1, wherein the set of items have been selected from the plurality of items based on an acquisition threshold.

5. The method as described in claim 4, wherein the acquisition threshold is based on a number of acquisitions or a number of acquisitions a number of views without acquisition of a respective said item.

6. The method as described in claim 1, wherein the refinement prompt includes an instruction to cause the language model to remove redundant words.

7. The method as described in claim 1, wherein the refinement prompt includes an instruction to cause the language model to reorder aspects of the set of text content.

8. The method as described in claim 1, wherein the refinement prompt includes an instruction to cause the language model to add aspects, respectively, to the set of text content.

9. The method as described in claim 1, wherein the refinement prompt includes an instruction to cause the language model to expand descriptive words included in the set of text content.

10. A computing device comprising:
a processing device; and
a computer-readable storage medium storing instructions that, responsive to execution by the processing device, causes the processing device to perform operations including:
receiving input text content as a guide for use in generating a listing of an item on a listing digital service of a service provider system;
receiving refined text content from a machine-learning model responsive to processing the input text content, the machine-learning model trained using training data selected from listings of items that were previously acquired via the listing digital service; and
generating the listing of the item for surfacing by the listing digital service as including the refined text content.

11. The computing device as described in claim 10, wherein the refined text content is a title for the listing of the item.

12. The computing device as described in claim 10, wherein the refined text content is a description of the item in the listing.

13. The computing device as described in claim 10, wherein the listings of items that were previously acquired via the listing digital service are selected based on an acquisition threshold.

14. The computing device as described in claim 10, wherein the training data from the listings of items is refined using a language model.

15. One or more computer-readable storage media storing instructions that, responsive to execution by a processing device, causes the processing device to perform operations comprising:
identifying a set of items from a plurality of items that have been selected for acquisition from a listing digital service of a service provider system;
locating a set of titles from listings associated with the set of items;
generating a set of refinement prompts based on the set of titles for processing by a language model;
receiving training data including a set of refined titles from the language model responsive to processing of the set of refinement prompts using machine learning; and
training a machine-learning model using the training data to implement generative artificial intelligence (AI) to generate a refined title, automatically and without user intervention, based on an input title.

16. The one or more computer-readable storage media as described in claim 15, wherein the set of items have been selected from the plurality of items based on an acquisition threshold.

17. The one or more computer-readable storage media as described in claim 15, wherein the refinement prompt includes an instruction to cause the language model to remove redundant words.

18. The one or more computer-readable storage media as described in claim 15, wherein the refinement prompt includes an instruction to cause the language model to reorder aspects of the set of titles.

19. The one or more computer-readable storage media as described in claim 15, wherein the refinement prompt includes an instruction to cause the language model to add aspects, respectively, to the set of titles.

20. The one or more computer-readable storage media as described in claim 15, wherein the refinement prompt includes an instruction to cause the language model to expand descriptive words included in the set of titles.
